(19) United States
(12) Patent Application Publication
(10) Pub. No.: US 2005/0099918 A1
(43) Pub. Date: May 12, 2005

(54) Apparatus and method for controlling recording and reproduction of data

(75) Inventors: Kiyoshi Tominaga, Osaka (JP); Yoshimitsu Nakamura, Nara (JP)

Correspondence Address: BACON & THOMAS, PLLC, 625 SLATERS LANE, FOURTH FLOOR, ALEXANDRIA, VA, 22314, US

(73) Assignee: Matsushita Electric Industrial Co., Ltd., Osaka (JP)

(21) Appl. No.: 10/981,442

(22) Filed: Nov. 5, 2004

(30) Foreign Application Priority Data
Nov. 6, 2003 (JP) 2003-376861

(51) Int. Cl. G11B 5/58

(52) U.S. Cl. 369/53.2; 369/53.31

(57) ABSTRACT

An apparatus for recording data, including a judging unit for judging at least one of a structure, a class and a property of the data; a recording unit for recording the data in a storage unit; a recording verification unit for performing a recording verification operation of the recorded data; and a recording control unit for controlling, based on a judging result of the judging unit, the recording verification unit to perform the verification operation on at least a portion of the data.

### FIELD OF THE INVENTION

The present invention relates to a digital information processing technology; and, more particularly, to recording and reproducing digital data in the field of the digital information processing technology.

### BACKGROUND OF THE INVENTION

Recordable recording media such as a rewritable disk (e.g., DVD-RAM), a re-recordable disk (e.g., DVD-RW) and a recordable disk (e.g., DVD-R) et al. have been rapidly popularized in these days in recording digital information. However, it may take much time to record a large amount of data due to a limitation on the speed of recording the data in the media, e.g., in case of recording an image on the recording media.

Particularly, in case a real-time recording is required, transferred data needs to be written in storage media in real-time. However, there is a limit on the amount of the data that can be recorded per unit time. Due to the above-described relation between a speed of transferring compressed data to be recorded and a speed of recording the data in the recording media, it is required to write compressed data with a higher quality on the recording media at a high speed with a high reliability.

Japanese Patent Publication No. H11-110140 discloses a conventional data recording apparatus. In the conventional apparatus, if the data transfer capability of recording media is insufficient to record transferred data on the recording media, the data to be recorded are temporarily stored in an auxiliary storage device which provides a faster access thereto than the recording media, and the data stored in the auxiliary storage device are transferred to the recording media when the recording media become available for recording.

The related art will now be explained in detail with reference to FIG. 4, which illustrates a configuration of the conventional data recording apparatus. In FIG. 4, a recording status monitoring block 44 monitors a recording status of a storage device 42. Based on a monitoring result of the recording status monitoring block 44 obtained on the basis of the data transfer capability of the storage device 42 and the transfer rate of data to be recorded, a recording managing block 41 decides whether or not the storage device 42 is currently performing a recording operation. If the storage device 42 is currently performing the recording operation, the data to be recorded are temporarily stored in an auxiliary storage device 43.

However, in case data should be recorded in real-time and the transfer rate of the data is larger than the recording speed of the recording media, massive storage media may be required as the auxiliary storage device. Further, even when the transfer of the data to the data recording apparatus is completed, the recording of the data is not actually finished until all the data stored in the auxiliary storage device is recorded oh the storage device, which causes a delay between the completion of the data transfer and the actual completion of the recording thereof in the storage device.

Meanwhile, for a high speed recording, a verification operation, in which the recorded data are read and compared with the original data, may be omitted from the recording process. However, it is problematic in that the reliability of the recorded data becomes low as the recording speed increases due to the lack of the operation of reading and comparing data after the recording.

### SUMMARY OF THE INVENTION

It is, therefore, an object of the present invention to provide an apparatus and method for recording and reproducing digital data with an improved reliability while minimizing a decrease in a speed of processing the data.

In accordance with one aspect of the invention, there is provided an apparatus for recording data, including a judging unit for judging at least one of a structure, a class and a property of the data; a recording unit for recording the data in a storage unit; a recording verification unit for performing a recording verification operation of the recorded data; and a recording control unit for controlling, based on a judging result of the judging unit, the recording verification unit to perform the verification operation on at least a portion of the data.

In accordance with another aspect of the invention, there is provided an apparatus for reproducing data, including a reading unit for reading the data recorded in a storage unit; a judging unit for judging at least one of a structure, a class and a property of the read data; a reproduction verification unit for performing a verification operation on at least a portion of the read data; and a reproduction control unit for controlling, based on a judging result of the judging unit, the reproduction verification unit to perform the verification operation on said at least a portion of the read data.

In accordance with still another aspect of the invention, there is provided a method for recording data, including a judging step for judging at least one of a structure, a class and a property of the data; a recording step for recording the data in a storage unit; a recording verification step for performing a verification operation of the recorded data; and a recording control step for controlling, based on a judging result of the judging step, the recording verification step to perform the verification operation on at least a portion of the data.

In accordance with still another aspect of the invention, there is provided a method for reproducing data, including a reading step for reading data recorded in a storage unit; a judging step for judging at least one of a structure, a class and a property of the read data; a reproduction verification step for performing a verification operation on the read data; and a reproduction control step for controlling, based on a judging result of the judging step, the reproduction verification step to perform the verification operation on at least a portion of the data.

### BRIEF DESCRIPTION OF THE DRAWINGS

The above and other objects and features of the present invention will become apparent from the following description of preferred embodiments, given in conjunction with the accompanying drawings, in which:

FIG. 1 presents a configuration of a data recording apparatus in accordance with a first preferred embodiment of the present invention;

FIGS. 2A and 2B show schematic diagrams to explain operations of a judging unit;

FIG. 3 offers a configuration of a data reproducing apparatus in accordance with a second preferred embodiment of the present invention; and

FIG. 4 provides a configuration of a conventional data recording apparatus.

### DETAILED DESCRIPTION OF THE PREFERRED EMBODIMENTS

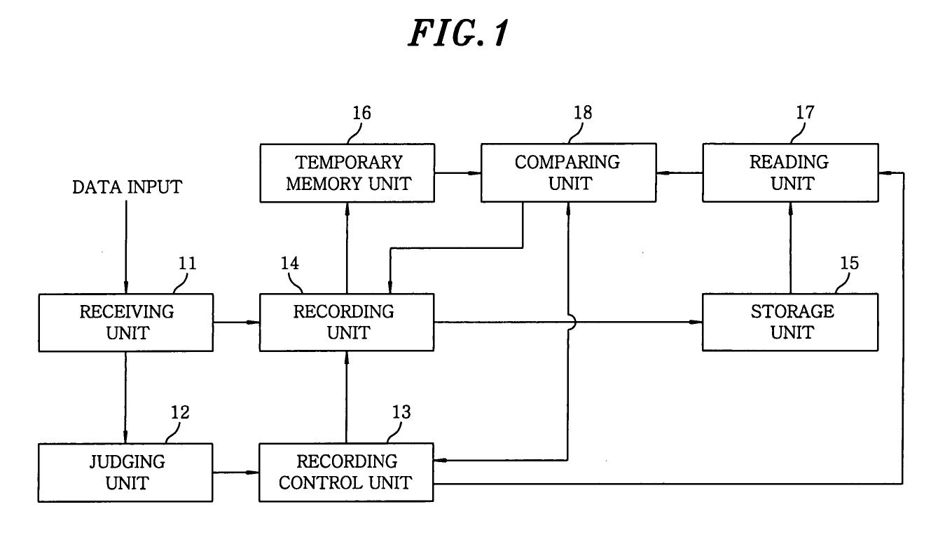

A first preferred embodiment in accordance with the present invention will now be described with reference to FIG. 1, which presents a configuration of a data recording apparatus in accordance with the first preferred embodiment.

In FIG. 1, reference numeral 11 indicates a receiving unit that receives data including at least one of image, sound and text information; reference numeral 12 represents a judging unit that analyzes a structure, a class and/or a property of the data received by the receiving unit 11 to determine importance of the data; reference numeral 13 denotes a recording control unit that decides which method will be used for recording the data received by the receiving unit 11, based on the importance of the data which is determined by the judging unit 12; reference numeral 14 depicts a recording unit that records the data received by the receiving unit 11; reference numeral 15 indicates a storage unit that stores the data being recorded by the recording unit 14; reference numeral 16 represents a temporary memory unit that temporarily stores the data being recorded by the recording unit 14; reference numeral 17 denotes a reading unit that reads the data recorded on the storage unit 15; and reference numeral 18 depicts a comparing unit that decides whether a re-recording is required or not by comparing the data stored in the temporary memory unit 16 (the data before recording) with the data stored in the storage unit 15 (the data after recording), wherein the latter is to be read by the reading unit 17.

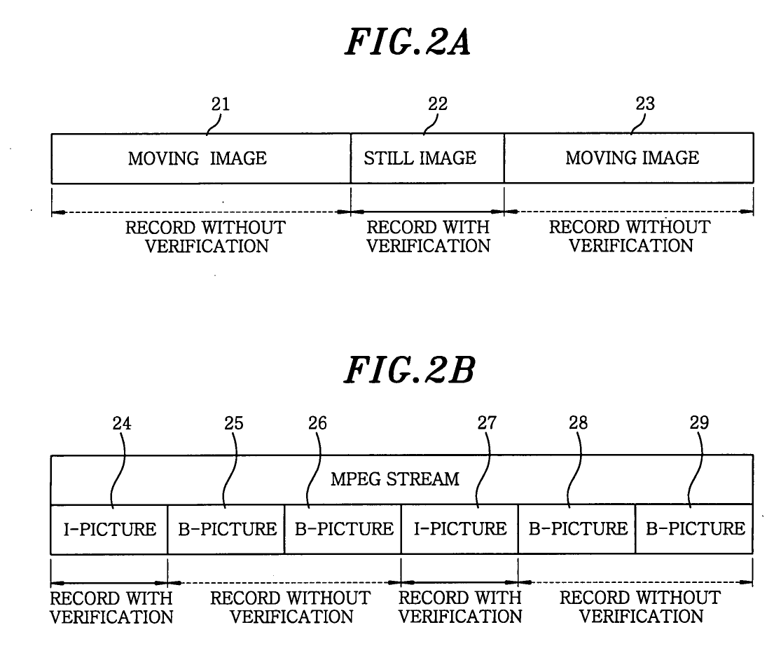

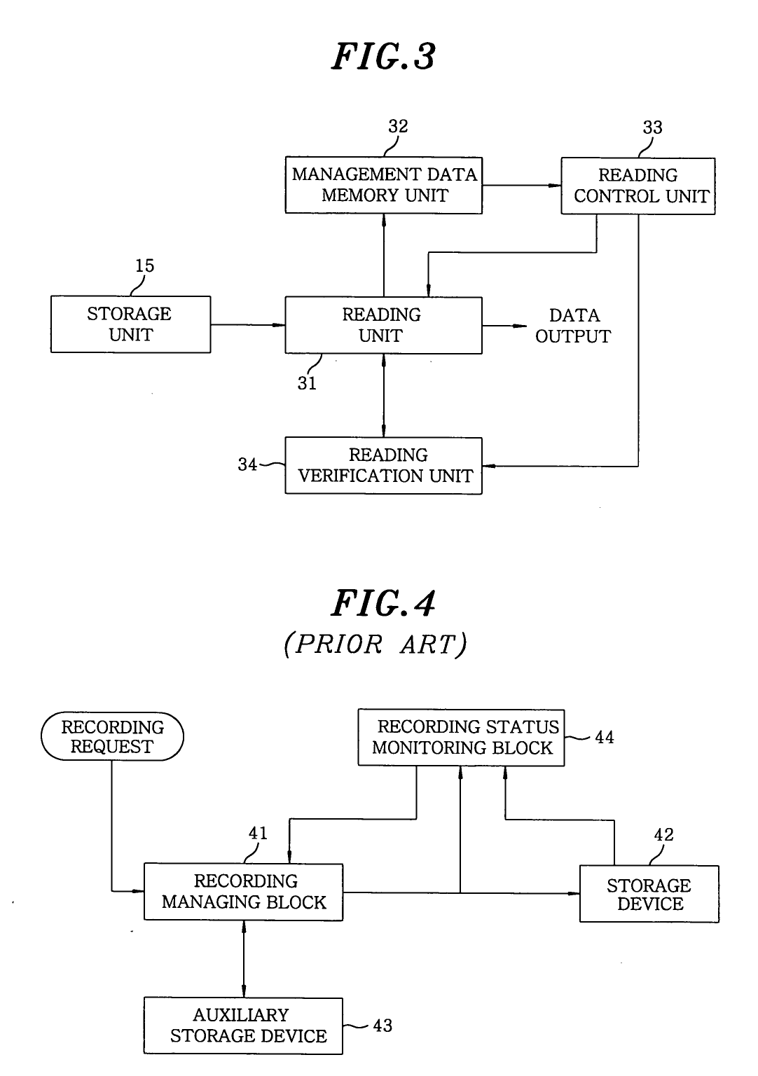

FIGS. 2A and 2B show schematic diagrams to explain operations of the judging unit 12 in accordance with the first embodiment of the present invention. Operations of the data recording apparatus and the judging unit 12, configured as above in accordance with the first preferred embodiment, will now be explained with reference to FIGS. 1, 2A and 2B.

First, the receiving unit 11 receives data, which includes at least one of image, sound and text information. The judging unit 12 analyzes information such as a structure, a class and/or a property of the data received by the receiving unit 11, and decides whether the received data is an important portion or not. Subsequently, the recording control unit 13 controls how to record the received data in the recording media, i.e., the storage unit 15, on the basis of the importance decided by the judging unit 12. The recording unit 14 records the received data in the storage unit 15. At this time, in case the judging unit 12 has decided that the received data is data of a high importance, i.e., requiring a high recording reliability, the recording control unit 13 controls the recording unit 14 to temporarily store the data in the temporary memory unit 16. After storing the data on both the storage unit 15 and the temporary memory unit 16, the reading unit 17 reads the data stored in the storage unit 15 and provides the read data to the comparing unit 18, which compares the data before recording (the data stored in the temporary memory unit 16) with the data after recording (the data stored in the storage unit 15), wherein the latter is to be read by the reading unit 17, to decide whether the data has been correctly recorded in the storage unit 15 or not. If the comparison result indicates that the data is not correctly recorded, the recording control unit 13 sends a re-recording command to the recording unit 14.

Here, the data that is decided by the judging unit 12 to be of a high importance and so requires a high recording reliability may be, e.g., a still image whose display duration per a unit amount of data is longer than that of a moving image. In general, the moving image has a predetermined display duration per one frame. Therefore, even though one frame of data is of a low recording reliability, it is shortly refreshed by the next frame of data. Consequently, the frame of a low quality affects the quality of the moving image only during its display duration. In contrast, as for the still image, the display duration for one frame thereof can be arbitrarily set, mostly, to be longer than that of one frame of the moving image. Therefore, a recording defect contained in one frame of the still image affects the quality thereof more than that of the moving image does.

In addition, in case the received data is a compressed image, a reference frame thereof can be considered as data of a high importance, i.e., requiring a high recording reliability. This is because a defect in the reference frame influences all the other frames which are constructed by using differences from the reference frame data.

Further, header information included in the received data and/or management information included in a pack structure of MPEG data are decided as data of a high importance, i.e., requiring a high reliability, since such data contains operational control information for an image to be displayed and/or defines positional relationship of preceding and subsequent data to thereby affect contents of the preceding and subsequent data. And, other types of data, e.g., subpicture information, that is displayed for a relatively long period of time may also be decided as data of a high importance, i.e., requiring a high reliability.

Criteria used in deciding the importance of the received data are not limited to those described above. It is clear to those skilled in the art that various modifications thereof may be made in accordance with the spirit of the present invention.

Hereinafter, operations of the judging unit 12 will be explained more in detail with reference to FIGS. 2A and 2B. In FIG. 2A, reference numerals 21 and 23 indicate moving image data while reference numeral 22 represents still image data. When the data shown in FIG. 2A is recorded in storage media, based on information of the data structure, the moving image data 21 and 23 are recorded without performing a recording verification operation thereon while the still image data 22 are recorded with performing a recording verification operation.

The moving image data 21 and 23 are, e.g., MPEG data, and the still image data 22 is, e.g., JPEG data or I-Picture data of MPEG data.

Further, when the data to be recorded is MPEG data, a picture structure of the MPEG data as shown in FIG. 2B is investigated. In FIG. 2B, reference numerals 24 and 27 indicate intra-coded pictures (I-Pictures) of the MPEG data and reference numerals 25, 26, 28 and 29 represent bidirectionally predictive-coded pictures (B-Pictures) of the MPEG data. In this case, the I-Pictures 24 and 27 are recorded through a recording verification process thereof while the other pictures are recorded without a recording verification process.

As described above, since only a still image having a long display duration or I-Picture data, which is a reference frame for other data related thereto, are recorded through a verification process thereof by virtue of the importance decision, it is possible to improve the reliability of the recorded data while minimizing a decrease in the recording transfer speed of the data.

A second preferred embodiment in accordance with the present invention will now be described with reference to FIG. 3, which offers a configuration of a data reproducing apparatus in accordance with the second preferred embodiment.

In FIG. 3, reference numeral 15 indicates a storage unit that stores data including at least one of image, sound and text information, and management data thereof; reference numeral 31 represents a reading unit that reads the data recorded in the storage unit 15; reference numeral 32 denotes a management data memory unit that stores management data read by the reading unit 31; reference numeral 33 depicts a reading control unit that determines a data reading method based on the management data stored in the management data memory unit 32; and reference numeral 34 indicates a reading verification unit that decides whether the data read by the reading unit 31 is correct or not.

Here, the management data stored in the management data memory unit is, e.g., data in an IFO file on which navigation data is recorded in accordance with a DVD standard.

Operations of the data reproducing apparatus, configured in accordance with the second preferred embodiment, will now be explained with reference to FIG. 3. The reading unit 31 reads management data of the data recorded in the storage unit 15, which stores data, including at least one of image, sound and text information, and management data thereof. The read management data is stored and maintained in the management data memory unit 32. While the reading unit 31 is reading the data including, e.g., at least one of image, sound and text information, the reading control unit 33 refers to the management data thereof stored in the management data memory unit 32 to determine a method for reading the data in accordance with a structure, a class and/or a property of the data, which is recognized based on the management data. In case the data reading method includes a step of verifying the data, the reading verification unit 34 examines the data read by the reading unit 31 by employing, e.g., an error checksum method, and issues a re-reading command to the reading unit 31 if the read data is incorrect.

Here, the data, which is determined by the reading control unit 33 to undergo a reading verification process, is, e.g., a still image whose display duration per a unit amount of data is longer than that of a moving image. In general, the moving image has a predetermined display duration for one frame. Further, although one frame of data is of a low recording or reading reliability, it is shortly refreshed by the next frame of data. Consequently, it affects a quality of the moving image during only the display duration of one frame. In contrast, as for the still image, the display duration of one frame can be arbitrarily set, mostly, to be longer than that of one frame of the moving image. Therefore, a defect in one frame of the still image lasts for a longer display duration to thereby have a large influence on the quality of the still image.

In addition, in case the data to be read is a compressed image, a reference frame thereof may be considered as data of a high importance, i.e., requiring a high reading reliability. This is because a defect in the reference frame influences all the other frame data which are generated by using differences from the reference frame data.

Further, header information included in the received data and/or management information included in a pack structure of MPEG data are decided as data of a high importance, i.e., requiring a high reliability, since such data contains operational control information for an image to be displayed and/or defines positional relationship of preceding and subsequent data to thereby affect contents of the preceding and subsequent data. And, other types of data, e.g., subpicture information, that is displayed for a relatively long period of time may also be decided as data of a high importance, i.e., requiring a high reliability. However, criteria used in the method for determining the importance of the read data are not limited to those described above, and it is clear to those skilled in the art that various modifications thereof may be made in accordance with the spirit of the present invention.

Since only a still image having a long display duration or data, which is a reference frame for data related thereto, are read through a reading verification process thereof by virtue of the importance decision, it is possible to improve the reliability of the read data while minimizing a decrease in the reading transfer speed of the data.

As mentioned above, in accordance with the present invention, when recording data in recording media, the importance of the data is decided based on a structure, a class and/or a property information of the data. Further, a recording verification process thereof is executed only if the importance of the data is high, i.e., the data requires a high recording reliability. Therefore, it is possible to improve the reliability of the recorded data while minimizing a decrease in the recording transfer speed of the data.

Further, in reading data from recording media, with reference to management data of the data recorded on the recording media, it is decided whether to execute a reading verification process on the data or not based on a structure, a class and/or a property information of the data. Therefore, it is possible to improve the reliability of the read data while minimizing a decrease in the reading transfer speed of the data.

It should be apparent to those skilled in the art that the data recording apparatus and the data reading apparatus described above can be combined in a data recording and reading apparatus, and the data recording and reading apparatus can be included in another apparatus such as, e.g., a digital camera, a digital camcoder and a computer.

While the invention has been shown and described with respect to the preferred embodiments, it will be understood by those skilled in the art that various changes and modifications may be made without departing from the spirit and scope of the invention as defined in the following claims.

1. An apparatus for recording data, comprising:
a judging unit for judging at least one of a structure, a class and a property of the data,
a recording unit for recording the data in a storage unit;
a recording verification unit for performing a recording verification operation of the recorded data; and
a recording control unit for controlling, based on a judging result of the judging unit, the recording verification unit to perform the verification operation on at least a portion of the data.

2. The apparatus of claim 1, wherein the recording control unit controls the recording unit to re-record said at least a portion of the data in the storage unit depending on a result of the verification operation of the recording verification unit.

3. The apparatus of claim 1, wherein the recording verification unit includes:
a temporary memory unit for storing said at least a portion of the data before being recorded in the storage unit;
a comparing unit for comparing said at least a portion of the data read from the storage unit with said at least a portion of the data stored in the temporary memory unit.

4. The apparatus of claim 1, wherein the recording control unit controls the verification operation to be performed on said at least a portion of the data if said at least a portion of the data affects another portion of the data.

5. The apparatus of claim 1, wherein the recording control unit controls the verification operation to be performed on said at least a portion of the data if said at least a portion of the data is a still image, an I-Picture (intra-coded picture) of MPEG data or subpicture information.

6. The apparatus of claim 4, wherein the recording control unit controls the verification operation to be performed on said at least a portion of the data if said at least a portion of the data is header information or management information in a pack structure of MPEG data.

7. An apparatus for reproducing data, comprising:
a reading unit for reading the data recorded in a storage unit;
a judging unit for judging at least one of a structure, a class and a property of the read data;
a reproduction verification unit for performing a verification operation on at least a portion of the read data; and
a reproduction control unit for controlling, based on a judging result of the judging unit, the reproduction verification unit to perform the verification operation on said at least a portion of the read data.

8. The apparatus of claim 7, wherein the reproduction control unit controls the reading unit to re-read said at least a portion of the data depending on the result of the verification operation of the reproduction verification unit.

9. The apparatus of claim 7, wherein the reproduction verification unit includes means for inspecting said at least a portion of the read data by using an error checksum method.

10. The apparatus of claim 7, wherein the reproduction control unit controls the verification operation to be performed on said at least a portion of the data if said at least a portion of the data affects another portion of the data.

11. The apparatus of claim 7, wherein the reproduction control unit controls the verification operation to be performed on said at least a portion of the data if said at least a portion of the data is a still image, an I-Picture (intra-coded picture) of MPEG data or subpicture information.

12. An apparatus for reproducing the data recorded in the storage unit of the data recording apparatus of claim 1, comprising:
a reading unit for reading the data recorded in the storage unit;
a reproduction control unit for determining a reproduction verification operation on at least a portion of the read data; and
a reproduction verification unit for performing the reproduction verification operation on said at least a portion of the read data if the reproduction control unit determines the reproduction verification operation on said at least a portion of the data,
wherein the reproduction control unit controls the reading unit to re-read said at least a portion of the data recorded in the storage unit, depending on a result of the reproduction verification operation of the reproduction verification unit.

13. An equipment having a data recording and reading apparatus, which comprises the data recording apparatus of claim 1.

14. The equipment of claim 13, wherein the data recording and reading apparatus further comprises:
a reading unit for reading the data recorded in the storage unit;
a reproduction verification unit for performing a verification operation on at least a portion of the read data; and
a reproduction control unit for controlling, based on a judging result of the judging unit, the reproduction verification unit to perform the verification operation on said at least a portion of the read data,
wherein the reproduction control unit controls the reading unit to re-read said at least a portion of the data depending on the result of the verification operation of the reproduction verification unit.

15. The equipment of claim 13, wherein the equipment is a digital camera, a digital camcoder or a computer.

16. A method for recording data, comprising:
a judging step for judging at least one of a structure, a class and a property of the data;
a recording step for recording the data in a storage unit;
a recording verification step for performing a verification operation of the recorded data; and
a recording control step for controlling, based on a judging result of the judging step, the recording verification step to perform the verification operation on at least a portion of the data.

17. The method of claim 16, wherein the recording control step includes a step for re-recording said at least a portion of the data in the storage unit depending on the result of the verification operation of the recording verification step.

18. The method of claim 16, wherein the recording verification step includes:
a temporary memory step for storing said at least a portion of the data before recording in the storage unit;
a comparing step for comparing said at least a portion of the data read from the storage unit with said at least a portion of the data stored in the temporary memory step.

19. The method of claim 16, wherein the recording control step includes a step for controlling the verification operation to be performed on said at least a portion of the data if said at least a portion of the data affects another portion of the data.

20. A method for reproducing data, comprising:
a reading step for reading data recorded in a storage unit;
a judging step for judging at least one of a structure, a class and a property of the read data;
a reproduction verification step for performing a verification operation on the read data; and
a reproduction control step for controlling, based on a judging result of the judging step, the reproduction verification step to perform the verification operation on at least a portion of the data.

21. The method of claim 20, wherein the reproduction control step includes a step for re-reading said at least a portion of the data depending on the result of the verification operation of the reproduction verification step.

22. The method of claim 20, wherein the reproduction control step includes a step for controlling the verification operation to be performed on said at least a portion of the data if said at least a portion of the data affects another portion of the data.
